(19) United States
(12) Patent Application Publication
(10) Pub. No.: US 2026/0136176 A1
(43) Pub. Date: May 14, 2026

(54) AUTOMATED WI-FI NETWORK PACKET ANALYSIS

(71) Applicant: Ekahau, Inc., New York, NY (US)

(72) Inventors: Olli Alanen, Helsinki (FI); Janne Kurjenniemi, Jyväskylä (FI); Ari Tourunen, Helsinki (FI); Anssi Tauriainen, Helsinki (FI)

(73) Assignee: Ekahau, Inc., New York, NY (US)

(21) Appl. No.: 18/946,695

(22) Filed: Nov. 13, 2024

(51) Int. Cl. H04W 12/037

(52) U.S. Cl. CPC H04W 12/037

(57) ABSTRACT

The devices, systems, and methods described herein are directed to capturing a sequence of encrypted Wi-Fi packets and analyzing the contents of the encrypted Wi-Fi packets, as well as the sequence of the encrypted Wi-Fi packets. In some examples, the analysis of the sequence of encrypted Wi-Fi packets includes generating, with a trained machine learning model, a prediction whether the sequence of encrypted Wi-Fi packets corresponds with a success case traffic pattern or with an anomaly pattern. Based on the analysis, a set of Key Performance Indicator (KPI) values is calculated, and a list is generated, indicating which KPI values are below their corresponding threshold values. In further examples, a list of one or more recommendations is generated to improve at least one of the KPI values that are below their corresponding threshold values.

### FIELD

The subject matter described herein relates to devices, systems, and methods for optimizing Wi-Fi networks and more particularly to optimizing Wi-Fi networks based on an analysis of captured encrypted Wi-Fi packets.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices.

### SUMMARY

The devices, systems, and methods described herein are directed to capturing a sequence of encrypted Wi-Fi packets and analyzing the contents of the encrypted Wi-Fi packets, as well as the sequence of the encrypted Wi-Fi packets. In some examples, the analysis of the sequence of encrypted Wi-Fi packets includes generating, with a trained machine learning model, a prediction whether the sequence of encrypted Wi-Fi packets corresponds with a success case traffic pattern or with an anomaly pattern. Based on the analysis, a set of Key Performance Indicator (KPI) values is calculated, and a list is generated, indicating which KPI values are below their corresponding threshold values. In further examples, a list of one or more recommendations is generated to improve at least one of the KPI values that are below their corresponding threshold values.

### BRIEF DESCRIPTION OF THE DRAWINGS

FIG. 1 is a block diagram of a first example of a system for optimizing a Wi-Fi network. The system includes a measurement device and a computing device to perform the analysis.

FIG. 2 is a block diagram of an example of the measurement device shown in FIG. 1.

FIG. 3 is a block diagram of a second example of a system for optimizing a Wi-Fi network in which the measurement device is integrated into the computing device.

FIG. 4 is a flow chart of an example of a method for optimizing a Wi-Fi network.

### DETAILED DESCRIPTION

Since Wi-Fi networks are very widely deployed in different environments, one of the most important use cases is troubleshooting existing networks. Some examples of troubleshooting a Wi-Fi network involve capturing Wi-Fi packets and manually analyzing the captured packets. However, such an approach can be very tedious and requires highly skilled Wi-Fi professionals to perform the analysis. For example, in some of these troubleshooting examples, the packet capture and subsequent analysis may be separated into different work phases, meaning that there is only a limited amount of integration between capturing the packets and observing all of the captured packets for analysis.

Moreover, in some examples of Wi-Fi troubleshooting, the analysis may only permit visualization of which packets were received with which packet content. Thus, in some examples, the troubleshooting procedure may only provide filtering and sorting of content. Therefore, some of these troubleshooting procedures may not provide any intelligence regarding what may be causing problems in the Wi-Fi network, leaving users and administrators of the Wi-Fi network to arrive at their own conclusions as to the cause of the problems, based on the user's own knowledge and expertise.

In some cases, Internet Protocol (IP) connectivity related issues may cause problems in a Wi-Fi network. The examples set forth below may alleviate one or more of these problems. Generally speaking, the examples set forth below may facilitate Wi-Fi network optimization and/or troubleshooting by: receiving and capturing Wi-Fi traffic on packet/frame level of one or more clients; analyzing the captured packet content and their sequences; automatically detecting possible problems in the communication between client devices and access points; and providing recommendations and actions that a user may take to fix the identified problems.

More specifically, in some of the examples described herein, a sequence of encrypted Wi-Fi packets is captured. The contents of the encrypted Wi-Fi packets are analyzed, as well as the sequence of the encrypted Wi-Fi packets. Based on the analysis, a set of Key Performance Indicator (KPI) values is calculated, and a list is generated, indicating which KPI values are below their corresponding threshold values.

Many of the following examples are directed to performing an analysis of connections between nodes of a wireless network. As used herein, a “connection analysis” refers to an analysis meant to evaluate a connection between nodes of the wireless network. As used herein, an “optimization analysis” refers to an analysis to evaluate a connection between nodes and, if appropriate, the generation of one or more recommendations to optimize the connection. A “troubleshooting procedure,” as used herein, refers to a procedure by which a node having connectivity problems is evaluated and recommendations are made to improve connectivity for the node. As used herein, an “optimization analysis” and a “troubleshooting procedure” are both considered to be types of “connection analysis.” Thus, the devices, systems, and methods set forth herein may be utilized to perform various types of connection analyses, including an optimization analysis and/or a troubleshooting procedure. In this regard, any reference to a particular type of analysis or procedure is not intended to be limited to that particular analysis or procedure. Rather, it should be understood that any other suitable connection analysis or procedure may be performed in place of a particularly specified analysis or procedure in the following description.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

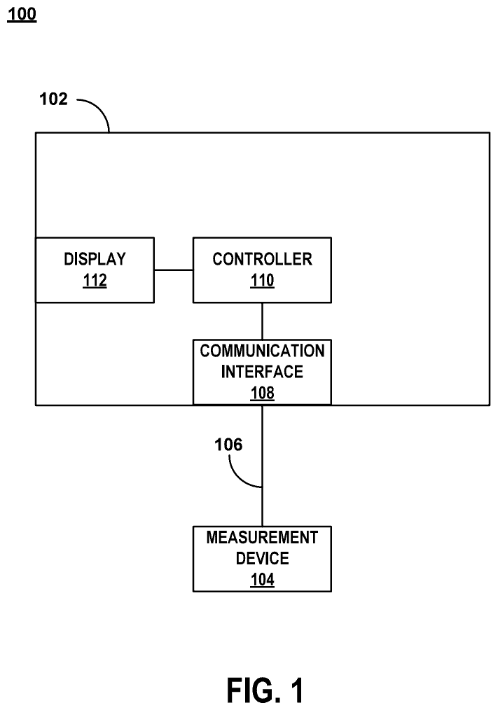

FIG. 1 is a block diagram of a first example of a system for optimizing a Wi-Fi network. The system includes a measurement device and a computing device to perform the analysis. In the example shown in FIG. 1, Wi-Fi network optimization system 100 includes local computing device 102 and measurement device 104. In some examples, local computing device 102 can be any on-site computing device that can receive and process data associated with a Wi-Fi network. For example, local computing device 102 could be a tablet computer, a laptop computer, a smartphone, or a desktop computer. In other examples, any other suitable computing device, even a remote, off-site computing device, could be used to perform the functions described herein.

Local computing device 102 includes communication interface 108, controller 110, and display 112. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

Controller 110 includes any combination of hardware, software, and/or firmware for executing the functions described herein. An example of a suitable controller 110 includes software code running on a microprocessor or processor arrangement connected to memory (not explicitly shown).

Display 112 is used to display, to a user, the results of an analysis performed on Wi-Fi packets captured by measurement device 104. In some examples, display 112 may be used to display, to the user, a set of Key Performance Indicator (KPI) values that were calculated based on the captured packets. In further examples, display 112 may be used to display, to the user, a list of one or more recommendations to improve at least one of the KPI values that are below their corresponding threshold values. In other examples, any other Wi-Fi network relevant information may also be displayed to the user via display 112. In some examples, display 112 includes an associated input mechanism (e.g., touchscreen, keyboard, microphone, etc.) by which the user can select one or more actions to take to improve at least one of the KPI values that are below their corresponding threshold values.

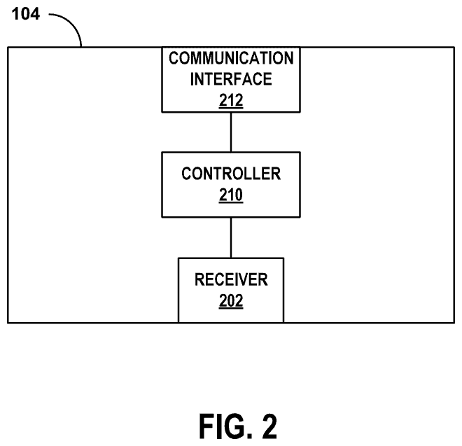

FIG. 2 is a block diagram of an example of measurement device 104 shown in FIG. 1. In the example shown in FIG. 2, measurement device 104 includes receiver 202 to receive Wi-Fi signals from various nodes of a Wi-Fi network. In other examples, measurement device 104 may have any suitable number of receivers. Regardless of the number of receivers in measurement device 104, each receiver is capable of scanning and monitoring a set of Wi-Fi channels and capturing all Wi-Fi link layer frames (e.g., packets) being heard on those channels, in some examples. In other examples, a single Wi-Fi radio (e.g., receiver), module, or chipset can be configured to operate on the separate channels at the same time, which is referred to as a Dual Band Simultaneous (DBS) configuration. Thus, the functionality of the measurement device, as described herein, may be accomplished with a measurement device having multiple receivers or a single, properly configured receiver.

The measurement device 104 shown in FIG. 2 also includes controller 210, which processes the signals received by receiver 202. Controller 210 includes any combination of hardware, software, and/or firmware for executing the functions described herein. An example of a suitable controller 210 includes software code running on a microprocessor or processor arrangement connected to memory (not explicitly shown). It is worth noting that, in some examples, any of the functions described herein as being performed by controller 110 may be performed by controller 210, and vice versa.

Measurement device 104, as shown in FIG. 2, also includes communication interface 212, which measurement device 104 uses to communicate with local computing device 102 via communication link 106. In some examples, the communication between measurement device 104 and local computing device 102 includes providing data to local computing device 102 and receiving command instructions regarding which one or more channels of the Wi-Fi network are selected for further analysis. In some examples in which one or more channels are selected for further analysis, controller 210 can dynamically configure receiver 202 to monitor particular channels during the analysis.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

In operation, measurement device 104 uses receiver 202 to receive Wi-Fi signals transmitted via one or more channels utilized by the nodes of a Wi-Fi network. For example, the received Wi-Fi signals may be transmitted by one or more client devices and/or one or more access points of the Wi-Fi network. As used herein, a “node of a Wi-Fi network” can be used to describe any device that is capable of sending or receiving data to and from other nodes of the Wi-Fi network. In some examples, a “node” may be an end device, also referred to herein as a client device, that serves as a source point or a destination point in the communication that occurs on the Wi-Fi network. Examples of an end device include a laptop or desktop computer, a work station, a tablet, a mobile phone, a printer, a scanner, or a server, etc. In other examples, a “node” may be an intermediary device that is designed to forward data between other devices in the Wi-Fi network. Examples of an intermediary device include wireless access points, routers, or repeaters, etc.

In some examples, the Wi-Fi signals contain a sequence of encrypted Wi-Fi packets. In these examples, measurement device 104 may transmit data regarding the sequence of encrypted Wi-Fi packets to local computing device 102. In some of these examples, the transmitted data is a forwarded signal containing the encrypted Wi-Fi packets. Local computing device 102 uses controller 110 to perform an analysis of the contents of the encrypted Wi-Fi packets and/or the sequence of encrypted Wi-Fi packets.

In some examples, the analysis of the sequence of encrypted Wi-Fi packets includes generating, with a trained machine learning model, a prediction whether the sequence of encrypted Wi-Fi packets corresponds with a success case traffic pattern or with an anomaly pattern. By generating a prediction of whether the sequence of encrypted Wi-Fi packets corresponds with a success case traffic pattern or with an anomaly pattern, it is not necessary to decode all the data from the encrypted packets to determine if the Wi-Fi transaction (e.g., a Dynamic Host Configuration Protocol (DHCP) transaction or a Domain Name System (DNS) transaction) was successful or not, which can be advantageously utilized to determine if the channel over which the encrypted Wi-Fi signals were sent should be optimized.

In the examples that utilize machine learning models, the models can be trained in advance to learn how to differentiate between the success case traffic patterns and the anomaly patterns. In some examples, machine learning training may require classified data that can be created manually so that the machine learning model can be trained to detect different problematic conditions in the Wi-Fi network.

One example of a suitable machine learning model for the detection of Internet Protocol (IP) addresses is a gradient boosting decision tree model. The gradient boosting decision tree model makes predictions based on a set of features extracted from the data frames observed in a recent time window (e.g., 30 seconds). The gradient boosting decision tree model returns two score values (“logits”) that represent the probability values for the two following events: “client does not have an IP address” and “client has an IP address.” The predictions are made every second. The values of the second score (“client has an IP address”) are accumulated in a sliding window buffer. If the mean of the values in the buffer exceeds a threshold value, then it is determined that the client has an IP address, and an affirmative result of “OK” is returned. If according to the model predictions, the client currently does not have an IP address, but at some point in time, the client did have an IP address, then a low confidence result of “?” is returned. If the client has never had an IP address, then a negative result of “−” is returned. The aforementioned threshold value may be obtained during the model training in advance.

One example of a suitable machine learning model for the detection of DNS service availability is gradient boosting decision tree model. The gradient boosting decision tree model makes predictions based on a set of features extracted from the data frames observed in the recent time window (e.g., 30 seconds). The gradient boosting decision tree model returns two score values (logits) that represent the probability values for the two following events: “there is a problem with the router and/or DNS server” and “everything is working fine.” The predictions are made every second. The values of the second score (“everything is fine”) are accumulated in a sliding window buffer. If the mean of the values in the buffer exceeds a threshold, then it is determined that the DNS service is available, and an affirmative result of “OK” is returned. If according to the model predictions, the DNS service is not available, but at some point the DNS service was available, then a low confidence result of “?” is returned. If the DNS service was never available, then a negative result of “−” is returned. The aforementioned threshold value may be obtained during the model training in advance.

Following are examples of features for each 30-second interval of each Wi-Fi “session” that may be extracted for the following frame categories: data frames that are not Extensible Authentication Protocol (EAP) over Local Area Network (LAN) (EAPOL); data frames that are not EAPOL and unicast; data frames that are not EAPOL, unicast and from Distribution System (DS); data frames that are not EAPOL, unicast and to DS; and data frames that are not EAPOL, broadcast and to DS. In other examples, features may be extracted for any other suitable frame categories.

In some examples, the following features may be extracted: average frame size (e.g., sum of payloads divided by the number of frames); average throughput (e.g., sum of payloads divided by the duration); average delay (e.g., time difference between a data frame and the next data frame if they are sent in opposite directions); number of frames; number of frames with non-zero payload; number of frames with payload of length between 0 and 500; number of frames with payload of length between 500 and 1000; and number of frames with payload of length above 1000. In some examples, average frame size, average throughput, and average delay are calculated directly from the data frames observed during the time window. However, the other features (e.g., metrics) may be normalized by dividing the value by: the number of frames, the duration of the interval under consideration, and the total payload.

In some examples, there are five different frame categories, and the system may be configured to calculate 18 different metrics for each frame category. This results in 5×18=90 metrics in total. In other examples, any other suitable number of frame categories may be utilized, and any other suitable number of metrics may be calculated per frame category. Regardless of the number of frame categories utilized or the number of metrics calculated per frame category, when the metrics are collected from any Wi-Fi traffic, then a trained machine learning model can predict, based on the calculated metrics, the probability of certain events, such as whether the “client has IP address” and whether the “DNS service is working fine.”

Based on the analysis of the contents of the encrypted Wi-Fi packets and/or the sequence of encrypted Wi-Fi packets, controller 110 calculates a set of Key Performance Indicator (KPI) values associated with the one or more channels utilized by the nodes of the Wi-Fi network to transmit the Wi-Fi signals. Controller 110 may further generate a list indicating which KPI values are below their corresponding threshold values, in some examples. In further examples, display 112 may be used to display the list indicating which KPI values are below their corresponding threshold values. In other examples, there may be multiple corresponding threshold values for at least one particular KPI value, which define different operating ranges for that particular KPI value. Of course, any other suitable KPIs may be analyzed and used to detect possible problems or configuration errors, in other examples.

In other examples, controller 110 may generate a list of one or more reasons that at least one of the KPI values are below their corresponding threshold values. In further examples, controller 110 may generate a list of one or more recommendations to improve at least one of the KPI values that are below their corresponding threshold values. Following is an example of a reason that a KPI value may be below a threshold value and a corresponding recommendation to improve the KPI value: “Client device didn't get IP address from DHCP system. Please check the operation of DHCP.” In other examples, the list of recommended actions may include changing the network configuration and/or changing client device settings to improve one or more KPI values. Display 112 may be used to display the list of reasons that one or more of the KPI values are below their corresponding threshold values and/or the list of one or more recommendations to improve at least one of the KPI values, in some examples.

In some examples, the user may use display 112 or an associated input mechanism (e.g., touchscreen, keyboard, microphone, etc.), to select one or more recommendations (e.g., recommended actions) to perform to improve at least one of the KPI values. In response to the user selecting one or more of the recommendations from the list, the controller 110 performs the corresponding recommended action(s), in some examples. In this manner, the Wi-Fi network optimization system 100 optimizes the performance of the Wi-Fi network. In other examples, system 100 may be configured to automatically perform an optimization analysis or a troubleshooting procedure on nodes identified by controller 110 as having connectivity problems.

Although the example shown in FIG. 1 utilizes controller 110 to perform the functions described above, controller 210 of measurement device 104 may be utilized to perform some, or all, of the functions described herein, in other examples.

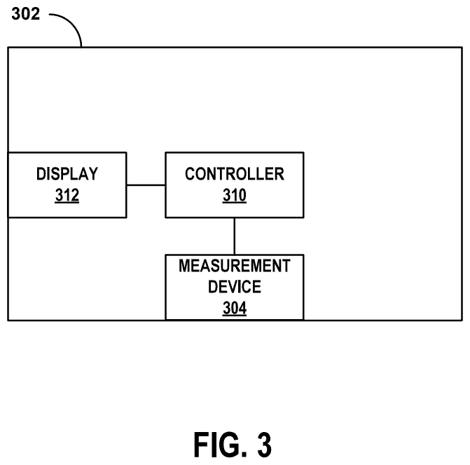

FIG. 3 is a block diagram of a second example of a system for optimizing a Wi-Fi network in which the measurement device is integrated into the computing device. In the example shown in FIG. 3, Wi-Fi network optimization system 302 includes measurement device 304, controller 310, and display 312. In the example shown in FIG. 3, controller 310 is capable of performing the combined functions of controller 110 and controller 210, as described in connection with FIGS. 1 and 2. Thus, Wi-Fi network optimization system 302 performs the combined functions of measurement device 104 and local computing device 102, as described herein.

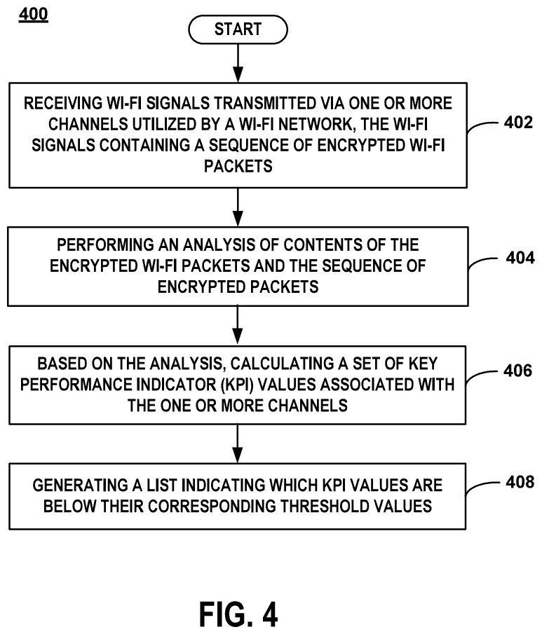

FIG. 4 is a flow chart of an example of a method for optimizing a Wi-Fi network. The method 400 begins at step 402 with receiving Wi-Fi signals transmitted via one or more channels utilized by a Wi-Fi network. In the example shown in FIG. 4, the Wi-Fi signals contain a sequence of encrypted Wi-Fi packets. At step 404, the method continues with performing an analysis of the contents of the encrypted Wi-Fi packets and the sequence of encrypted Wi-Fi packets. In some examples, the analysis of the sequence of encrypted Wi-Fi packets includes generating, with a trained machine learning model, a prediction whether the sequence of encrypted Wi-Fi packets corresponds with a success case traffic pattern or with an anomaly pattern. At step 406, the method further includes calculating, based on the analysis, a set of Key Performance Indicator (KPI) values associated with the one or more channels. At step 408, the method also includes generating a list indicating which KPI values are below their corresponding threshold values. In other examples, one or more of the steps of method 400 may be omitted, combined, performed in parallel, or performed in a different order than that described herein or shown in FIG. 4. In still further examples, additional steps may be added to method 400 that are not explicitly described in connection with the example shown in FIG. 4.

In other examples, additional steps may be added to method 400 that are not explicitly described in connection with the example shown in FIG. 4. For example, for at least one particular KPI value, there may be multiple corresponding threshold values, which define different operating ranges for that particular KPI value, in some examples. In further examples, the method may also include generating a list of one or more reasons that at least one of the KPI values are below their corresponding threshold values. In still further examples, the method may additionally include generating a list of one or more recommendations to improve at least one of the KPI values that are below their corresponding threshold values.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A Wi-Fi network optimization system comprising:
a receiver to receive Wi-Fi signals transmitted via one or more channels utilized by a Wi-Fi network, the Wi-Fi signals containing a sequence of encrypted Wi-Fi packets; and
a controller to:
perform an analysis of contents of the encrypted Wi-Fi packets and the sequence of encrypted Wi-Fi packets,
based on the analysis, calculate a set of Key Performance Indicator (KPI) values associated with the one or more channels, and
generate a list indicating which KPI values are below their corresponding threshold values.

2. The Wi-Fi network optimization system of claim 1, wherein the analysis of the sequence of encrypted Wi-Fi packets includes generating, with a trained machine learning model, a prediction whether the sequence of encrypted Wi-Fi packets corresponds with a success case traffic pattern or with an anomaly pattern.

3. The Wi-Fi network optimization system of claim 1, wherein, for at least one particular KPI value, there are multiple corresponding threshold values, which define different operating ranges for that particular KPI value.

4. The Wi-Fi network optimization system of claim 1, wherein the controller further:
generates a list of one or more recommendations to improve at least one of the KPI values that are below their corresponding threshold values.

5. The Wi-Fi network optimization system of claim 1, wherein the controller further:
generates a list of one or more reasons that at least one of the KPI values are below their corresponding threshold values.

6. A method for optimizing a Wi-Fi network, the method comprising:
receiving Wi-Fi signals transmitted via one or more channels utilized by a Wi-Fi network, the Wi-Fi signals containing a sequence of encrypted Wi-Fi packets;
performing an analysis of contents of the encrypted Wi-Fi packets and the sequence of encrypted Wi-Fi packets;
based on the analysis, calculating a set of Key Performance Indicator (KPI) values associated with the one or more channels; and
generating a list indicating which KPI values are below their corresponding threshold values.

7. The method of claim 6, wherein the analysis of the sequence of encrypted Wi-Fi packets includes generating, with a trained machine learning model, a prediction whether the sequence of encrypted Wi-Fi packets corresponds with a success case traffic pattern or with an anomaly pattern.

8. The method of claim 6, wherein, for at least one particular KPI value, there are multiple corresponding threshold values, which define different operating ranges for that particular KPI value.

9. The method of claim 6, further comprising:
generating a list of one or more recommendations to improve at least one of the KPI values that are below their corresponding threshold values.

10. The method of claim 6, further comprising:
generating a list of one or more reasons that at least one of the KPI values are below their corresponding threshold values.
